(19) United States
(12) Patent Application Publication
(10) Pub. No.: US 2023/0371492 A1
(43) Pub. Date: Nov. 23, 2023

(54) METHOD FOR APPLYING A SPRAY ONTO AGRICULTURAL LAND

(71) Applicant: Robert Bosch GmbH, Stuttgart (DE)

(72) Inventor: Nicolas Houis, Bietigheim-Bissingen (DE)

(21) Appl. No.: 18/248,442

(22) PCT Filed: Sep. 22, 2021
(86) PCT No.: PCT/EP2021/076078

§ 371 Date: Apr. 10, 2023

(30) Foreign Application Priority Data
Dec. 15, 2020 (DE) 10 2020 215 874.6

(51) Int. Cl. A01M 7/00

(52) U.S. Cl. CPC A01M 7/0089; A01M 7/006

(57) ABSTRACT

A method for applying a spray onto agricultural land using at least one spray nozzle unit of an agricultural spraying device. The method includes: detecting a field section of the agricultural land using at least one optical detection unit to obtain image information on the field section with a depth in the travel direction of the spraying device; identifying plants in an image evaluation region of the obtained image information using a control unit, the image evaluation region representing a corresponding field evaluation region of the detected field section with a depth in the travel direction of the spraying device; and applying the spray onto the field evaluation region of the detected field section using the spray nozzle unit of the agricultural spraying device depending on the plants identified in the image evaluation region; and selecting a variable depth of the image evaluation region using the control unit.

### FIELD

The present invention relates to a method for applying a spray onto agricultural land using at least one spray nozzle unit of an agricultural spraying device and to a control unit and an agricultural spraying device for applying a spray.

### BACKGROUND INFORMATION

Algorithms for identifying rows of plants are available in the related art. These are most commonly based on camera shots taken from a field machine. These shots are taken at sharp angles of inclination and show as large a portion of the image as possible in order to simplify the detection of rows of plants as much as possible.

Methods for detecting and classifying weeds are also available, which are carried out using small high-resolution images, and preferably without an angle of inclination, in order to obtain sufficient image resolution for detecting small plant objects.

To ensure correct plant identification and, if necessary, also compensate interfering factors, successive images or evaluation regions in the images have to “overlap”. The higher the speed of the work machine, the higher the repetition rate has to be to set the selected or specified overlap between successive evaluation regions in the direction of travel.

A method for applying a plant protection agent, in which an evaluation portion has a specified constant length that is smaller than the length of an associated detected field section, is described in German Patent Application No. DE 10 2018 217 742 A1. The position of the specified evaluation portion in the field section is selected as a function of a driving speed of the spraying device.

### SUMMARY

The present invention provides a method for applying a spray onto agricultural land using at least one spray nozzle unit of an agricultural spraying device. According to an example embodiment of the present invention, the method includes:
detecting a field section of the agricultural land by means of at least one optical detection unit in order to obtain image information on the field section with a depth T(image) in the direction of travel of the spraying device;
identifying plants in an image evaluation region of the obtained item of image information by means of a control unit, wherein the image evaluation region represents a corresponding field evaluation region of the detected field section with a depth T(evaluation) in the direction of travel of the spraying device; and
applying the spray onto the field evaluation region of the detected field section by means of the spray nozzle unit of the agricultural spraying device as a function of the plants identified in the image evaluation region, wherein the following additional step is provided:
selecting a variable depth T(evaluation) of the image evaluation region by means of the control unit.

The present invention also provides a control unit. According to an example embodiment of the present invention, the control unit is configured to carry out and/or control the following steps:
identifying plants in an image evaluation region of an obtained item of image information of a detected field section of agricultural land with a depth T(image) in the direction of travel of a spraying device, wherein the image evaluation region represents a corresponding field evaluation region of the detected field section with a depth T(evaluation) in the direction of travel of the spraying device;
outputting a control signal to at least one spray nozzle unit of an agricultural spraying device as a function of the plants identified in the image evaluation region in order to apply the spray onto the field evaluation region of the detected field section,

wherein the control unit is further configured to carry out and/or control the following further step:
selecting a variable depth T(evaluation) of the image evaluation region, in particular as a function of a speed of the agricultural spraying device in the direction of travel.

The present invention also provides an agricultural spraying device for applying a spray onto agricultural land comprising at least one spray nozzle unit, at least one optical detection unit, in particular wherein an optical axis of the optical detection unit has an angle of inclination greater than 0° relative to the vertical in the direction of travel of the spraying device, and an above-described control unit of the present invention.

The present invention also provides a computer program which is configured to carry out and/or control the steps of an above-described method pf the present invention and/or an above-described control unit when the computer program is executed on a computer, and a machine-readable storage medium on which the computer program is stored.

The method is intended for, but not limited to, agricultural purposes. In the context of the present invention, an agricultural purpose can be understood to mean a purpose directed to economic cultivation of crop plants.

The spray is applied onto agricultural land or an area used for agriculture. This can be understood to mean a field or a plant cultivation area or also a parcel of such a cultivation area.

The agricultural land can thus be arable land, a grassland or a pasture. The plants can include crop plants, for example, the fruit of which is used agriculturally (for example as food, feed or as an energy crop) as well as waste plants, weeds and grass weeds.

All steps of the method are preferably carried out during a movement, in particular a travel or flight of the agricultural spraying device over the agricultural land. In the context of the present application, therefore, depending on the design of the spraying device, the term “direction of travel” can also be understood to mean a “direction of flight”.

The agricultural spraying device is advantageously configured to carry out the method in an automated and/or autonomous manner to enable quick, reliable and efficient treatment of a field.

The agricultural spraying device can in particular be part of an agricultural field sprayer or plant protection device, or can be configured as an agricultural field sprayer or plant protection device. The agricultural spraying device can comprise a mobile unit or can be disposed on a mobile unit, wherein the mobile unit can in particular be configured as a land vehicle and/or an aircraft and/or a trailer. The mobile unit can in particular be an agricultural work machine, for example a towing vehicle, a tractor, a self-driving or autonomous field sprayer, or a self-driving or autonomous robot. The agricultural spraying device can in particular be a towed field sprayer, a self-driving field sprayer, or a mounted field sprayer. The agricultural spraying device can also be mounted on a hydraulic device of an agricultural work machine. It is also possible that the agricultural spraying device is mounted on a loading area of an agricultural work machine. Alternatively, the spraying device can be hitched to the agricultural work machine. The agricultural spraying device or the field sprayer can comprise at least one spray tank to hold the spray. The agricultural spraying device or the field sprayer can also comprise a mixing unit, which mixes (blends) a spray concentrate with water directly on the agricultural spraying device to form the spray to be applied.

The spray is in particular a spray liquid. The spray can comprise or be an agricultural preparation or plant protection agent (PPA), in particular a plant protection agent concentrate. The spray can therefore comprise a pesticide, such as an herbicide, a fungicide or an insecticide. However, the spray can also comprise or be a fertilizer, in particular a fertilizer concentrate. The spray can comprise a growth regulator. The spray can comprise a granular active agent which has been mixed with a carrier liquid. The spray liquid can, for example, be a: liquid, suspension, emulsion, solution or a combination thereof. The spray liquid is preferably a plant protection agent diluted with water or a fertilizer diluted with water. The spray liquid can thus, for instance, be a spray mixture.

The application of the spray can in particular be carried out using a delivery unit. The delivery unit can be configured to deliver or conduct, in particular meter, a liquid and/or a granulate under pressure. The delivery unit can therefore, for example, comprise one or more pumps, feed pumps, metering pumps, pressure accumulators, screw conveyors, valves, apertures, etc.

The spray nozzle unit preferably comprises at least one spray nozzle for applying the spray and at least one valve for controlling or regulating the quantity of spray applied. The spray nozzle unit is accordingly configured such that it can be controlled or actuated. The valve can be disposed or integrated in the spray nozzle. The valve can, however, also be connected upstream of the spray nozzle, i.e., disposed upstream of the spray nozzle (in the direction of flow of the spray). However, the spray nozzle unit can also comprise multiple spray nozzles which each have an upstream valve. The spray nozzle unit can furthermore also comprise multiple spray nozzles with only one valve upstream of the spray nozzles, so that, when the valve is actuated, the spray is applied using all of the spray nozzles of the spray nozzle unit. The valve can be configured as a pulse-width modulated (PWM) valve or as a proportional valve. The spray nozzle unit can be configured as a partial width of a nozzle system of the agricultural spraying device. The spray nozzle units can be activated individually or separately and/or in defined groups or associations and/or all together. The spray nozzles of each spray nozzle unit can be activated individually or separately and/or in defined groups or associations and/or all together.

Each row of field sections (=field sections along the direction of movement or travel) can be assigned one or more spray nozzle unit(s) or spray nozzle(s) of a spray nozzle unit. Each row of field sections can be assigned exactly one spray nozzle unit or spray nozzle of a spray nozzle unit, for instance, or exactly two spray nozzle units or spray nozzles of a spray nozzle unit, in order to be treated.

The optical detection unit is preferably disposed on the agricultural spraying device. The optical detection unit can comprise at least one multispectral and/or hyperspectral and/or infrared camera and/or camera and/or 3D-camera. The optical detection unit can be configured to detect or record images in the NIR and/or visual range. The optical detection unit can comprise a light or illumination unit. The optical detection units can be configured to communicate with one another. Each row of field sections can be assigned an optical detection unit. However, it is also possible that one optical detection unit detects two or more rows of field sections. An optical axis of at least one optical detection unit preferably has an angle of inclination (a) greater than 0° relative to the vertical in the direction of travel of the spraying device. In other words, this means that the optical detection unit is inclined forward in the direction of travel.

The spray nozzle unit or the spray nozzle units and the optical detection unit or the optical detection units are preferably disposed on a spray boom of the agricultural spraying device.

According to an example embodiment of the present invention, the step of detecting the field sections can take place while the agricultural spraying device with the optical detection units is traveling across the field, for example. Of course, multiple field sections can be detected substantially simultaneously by multiple optical detection units.

The detected field section can be a detected portion or a detected portion of the image of an optical detection unit. The detected field section is preferably the entire field section detected in the field of view of the optical detection unit.

The image information represents the detected field section. The image information is preferably an image or map of the detected field section. The image information has a depth T(image) in the direction of travel of the spraying device and a width B(image) transverse to the direction of travel of the spraying device.

The method or the method steps are of course carried out repeatedly. The steps of detecting the field sections are preferably carried out or carried out repeatedly in a defined, in particular fixed, time interval or in a time interval adjusted to the speed of the agricultural spraying device. In other words, this means that the field sections are detected with a defined or a speed-dependent frame rate or frame frequency (=repetition rate).

The plants are identified at least in the image evaluation region. The plants can also be identified in the overall image information, for example if row identification is to be carried out. Identifying plants in the depth-variable image evaluation region of an obtained item of image information can, for example, be understood to mean determining the presence of plants in the field section or the field evaluation region, in particular without carrying out a classification of the individual plants. The step of identifying plants can include detecting a color component, in particular a green color component and/or an infrared component in the field section/field evaluation region or portion of the image/image evaluation region. Plants can be detected using the optical detection unit, e.g., based on a specified NDVI (Normalized Differenced Vegetation Index, which is formed from reflection values in the near infrared and visible red wavelength range of the light spectrum) by distinguishing biomass or vital plants and plant parts from the ground.

The image evaluation region is the region of the image information in which the plants are identified and which is evaluated by the control unit, for example to ascertain a plant index. The image evaluation region thus represents a corresponding field evaluation region of the detected field section. The image evaluation region has a depth T(evaluation) in the direction of travel of the spraying device and a width B(evaluation) transverse to the direction of travel of the spraying device. The depth T(evaluation) of the image evaluation region is generally smaller than the depth T(image) of the image information, but can also be the same size. The image evaluation region preferably has a minimum depth T(evaluation,min) of 20% and/or a maximum depth T(evaluation,max) of 100% of the depth T(image) of the image information. A width B(evaluation) of the image evaluation region can be smaller than a width B(image) of the image information.

It should be noted that additional separate image evaluation regions can be provided in the image information without leaving the scope of the present invention. The number of image evaluation regions per image information depends on the spray nozzle spacing and the width of the image information. Each image evaluation region can be assigned to a respective spray nozzle unit having one or more spray nozzles. At an image information width of 1.5 m and a 25 cm spray nozzle spacing, for example, 6 image evaluation regions per camera would be provided.

According to an example embodiment of the present invention, in the step of applying, in the case of a positive “spray decision”, the spray is applied onto the field evaluation region of the detected field section as a function of the plants identified in the image evaluation region or the ascertained plant index using the spray nozzle unit of the agricultural spraying device, preferably with a defined minimum quantity per area. The spray is preferably applied onto the entire field evaluation region. The field evaluation regions onto which the spray is applied with the defined minimum quantity per area are also referred to hereinafter as sprayed or treated field evaluation regions.

According to an example embodiment of the present invention, a step of ascertaining a plant index for the image evaluation region using the identified plants in the image evaluation region by means of the control unit is preferably provided, wherein, in the step of applying, the spray is applied onto the field evaluation region as a function of the ascertained plant index, in particular upon reaching and/or falling below and/or exceeding a defined threshold value for the plant index.

According to an example embodiment of the present invention, the plant index represents or is preferably a degree of coverage of the corresponding field evaluation region of plant material and/or a quantity of plant material in the respective field evaluation region and/or a number of identified plants in the respective and/or field evaluation region. The degree of coverage can be defined via the ratio of the area covered by plant material to the total area to be evaluated. The degree of coverage for the field evaluation region is therefore the ratio of the area of the region covered by plant material to the respective overall image evaluation region. The number of pixels in the respective image evaluation region in which plant material is detected can be determined for this purpose. Thus, a measure of the infestation can be derived by means of the plant index, as a function of which the decision is made whether and, if necessary, how (e.g., with which application quantity) the corresponding field evaluation region is sprayed or treated.

According to an example embodiment of the present invention, the threshold value can be manually enterable, a value which is defined beforehand and transmitted to the system, or a value which is preset and permanently on the system. A so-called spraying rule, i.e., a relationship between a determined plant index and the decision whether and how much plant protection agent should be applied, can be stored as a function of the crop in the field, the growth stage and the spray or plant protection agent used. As an example, the rule could be: “If the degree of coverage in the plant evaluation region exceeds 0.5%, an application is made to the field evaluation region.”

According to an example embodiment of the present invention, a step of identifying rows of plants in the image evaluation region and/or image information using the identified plants in the overall image information by means of the control unit can preferably be provided, wherein, in the step of applying, the spray is also applied as a function of identified rows of plants. The step of identifying or recognizing rows of plants can be carried out continuously or permanently. The step of identifying rows of plants is preferably carried out using and/or evaluating all or substantially all of the obtained image information, i.e., over the entire depth T(image).

According to an example embodiment of the present invention, the identification of the row of plants can advantageously be carried out using at least one of the following items of information: color component, in particular green color component of the detected plants, infrared component of the detected plants, plant spacing, plant row spacing, growth stage of the plants, geocoordinates of a sowing of the plants. Using this information or properties, the rows of plants can be identified in a simple and reliable manner. Since rows of plants extend substantially in a straight line, a row of plants can also be identified by fitting a straight line or a straight center line of the plant rows to an image trajectory having the highest portion of the color green or green value, for example.

In the step of identifying, preferably all of the rows of plants in the detected field section are identified.

The control unit can comprise a computing unit or a plurality of computing units for processing signals or data, at least one memory unit for storing signals or data, at least one communication interface for reading in data, in particular for receiving image information and outputting data, in particular control signals to a unit, in particular an actuator. Each optical detection unit can be assigned a computing unit, or each optical detection unit can comprise its own computing unit. The computing unit is or the computing units are configured or set up for image processing, so that it/they can carry out calculation steps or image processing steps to implement the method according to the present invention. Each computing unit accordingly comprises corresponding image processing software.

The computing unit can be a signal processor, a microcontroller or the like, for example, and the memory unit can be a flash memory, an EPROM or a magnetic memory unit. The communication interface can be configured to read in or output data wirelessly and/or by wire, wherein a communication interface capable of reading in or outputting data transmitted by wire can read said data, for example electrically or optically, from a corresponding data transmission line or output the data to a corresponding data transmission line.

The method according to the present invention can accordingly be implemented in software or hardware, for example, or in a mixed form of software and hardware, in the control unit or control unit.

The control unit can be disposed entirely or partially on or integrated into the agricultural spraying device. However, the control unit can also be entirely or partially external, for example integrated in a cloud.

According to the present invention, the depth T(evaluation) of the image evaluation region is variably selectable or adjustable by means of the control unit. In other words, this means that the image evaluation region is depth-variable. In the context of the present application, “variable selection” of a depth is intended to be understood as the selection or setting of a value for the depth. The depth T(evaluation) of the image evaluation region is advantageously selected by means of the control unit as a function of a speed of the agricultural spraying device in the direction of travel. In other words, this means that the depth T(evaluation) is likewise increased when the driving speed is increased. Alternatively or additionally, the depth T(evaluation) of the image evaluation region is preferably selected by means of the control unit as a function of a frame rate of detected field sections and/or a variable related to the temperature of the control unit.

The selection of the depth T(evaluation) can either be carried out within a downstream image processing software of the computing unit or, if supported by the optical detection unit or camera, directly as an ROI definition (region of interest) on the level of the imager chip of the optical detection unit or camera.

As explained above, to maintain a (specified) “overlap” of the image evaluation regions, the frame rate has to be increased, e.g., when the driving speed is increased. Increasing the frame rate massively increases the number of computing operations, however, because most operations are applied onto the entire image, which in turn leads to an undesirable increase in energy consumption and the associated thermal load. The method according to the present invention now makes it possible to keep constant or even reduce the frame rate by adjusting the depth T(evaluation) and thus keep substantially constant or reduce the energy consumption and thermal load. Thus, for example at increased speed, the depth T(evaluation) of the image evaluation region can be increased or extended in order to maintain the overlap without changing the frame rate.

According to an example embodiment of the present invention, it is advantageous if a rear edge of the image evaluation region in the direction of travel of the agricultural spraying device is aligned a rear edge of the image information in the direction of travel of the agricultural spraying device. In other words, this means that the edges overlap. This measure results in a maximum selectable depth range for T(evaluation), i.e., a maximum depth T(evaluation,max).

Alternatively, it is advantageous if a rear edge of the image evaluation region in the direction of travel of the agricultural spraying device is selected by means of the control unit as a function of a speed of the agricultural spraying device in the direction of travel. This measure makes it possible to increase the reaction distance, i.e., the distance between the image evaluation region and the spray nozzle unit, so that the maximum driving speed can be further increased.

### BRIEF DESCRIPTION OF THE DRAWINGS

The present invention will be explained in more detail in the following as an example with reference to the figures.

FIG. 1 shows a schematic illustration of an agricultural spraying device according to an example embodiment the present invention.

FIG. 2 shows a schematic illustration of a basic geometric arrangement of the optical detection unit and the spray nozzle unit with respect to one another, according to an example embodiment of the present invention.

FIG. 3 shows a schematic illustration of an obtained item of image information with a depth-variable image evaluation portion, according to an example embodiment of the present invention.

FIG. 4 shows a flowchart of a method according to an example embodiment of the present invention. In the following description of preferred embodiment examples of the present invention, the same or similar reference signs are used for the elements which are shown in the various figures and have a similar effect, and a repeated description of these elements is omitted.

### DETAILED DESCRIPTION OF EXAMPLE EMBODIMENTS

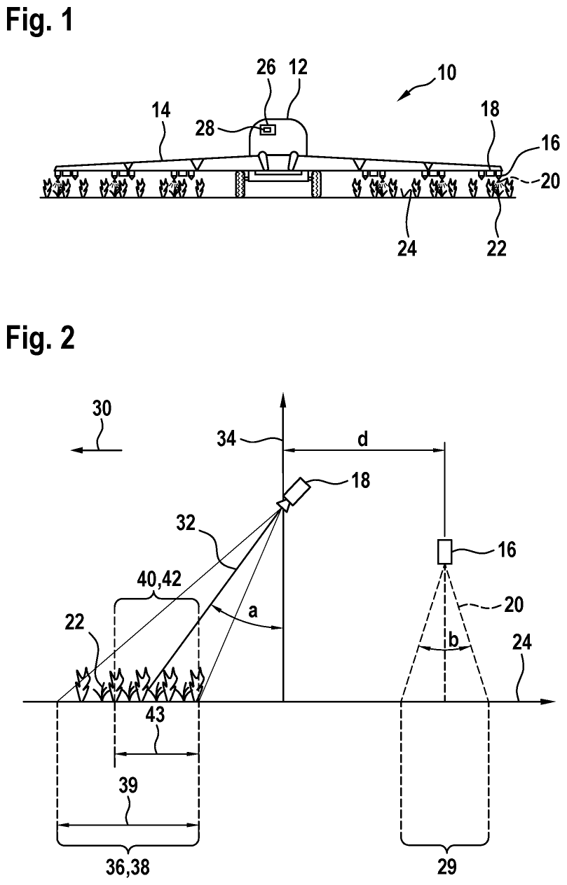

FIG. 1 shows a schematic illustration of an agricultural spraying device, which is provided in its entirety with the reference sign 10.

The agricultural spraying device 10 is configured as a field sprayer 10. The field sprayer 10 is disposed on a mobile land vehicle 12, which is configured as a towing vehicle 12 or tractor 12.

The agricultural spraying device 10 comprises a spray boom 14. Spray nozzle units 16 and optical detection units 18 are disposed on the spray boom 14. The spray nozzle units 16 are configured to apply a spray 20 onto plants 22 or waste plants 22 on agricultural land 24. The optical detection units 18 are configured as optical cameras 18. The optical cameras 18 each comprise a filter unit to extract a color component, for example the green color component, of an obtained or acquired item of image information or an acquired image in order to detect plants 22 or waste plants 22.

The agricultural spraying device 10 further comprises a (not depicted) delivery unit, by means of which the application quantity or the active ingredient quantity in the spray 20 to be applied can be adjusted or varied.

The agricultural spraying device 10 also comprises a control unit 26, which is connected to the optical cameras 18 to receive information from them. The control unit 26 comprises a computing unit 28, which is configured to carry out calculation steps or image processing steps to implement the method according to the present invention. The control unit 26 is further configured to output a control signal in such a way that the spray 20 is applied by means of the spray nozzle units 16 as a function of the ascertained plant index.

FIG. 2 shows a basic geometric arrangement of a spray nozzle unit 16, which, in the case of a positive spray decision, applies the spray 20 to a spray region 29, and an inclined optical detection unit 18 or a camera 18 on the agricultural spraying device 10. The angle of inclination a here is the angle in the direction of travel 30of the spraying device 10 between an optical axis 32 of the camera 18 and a vertical 34.

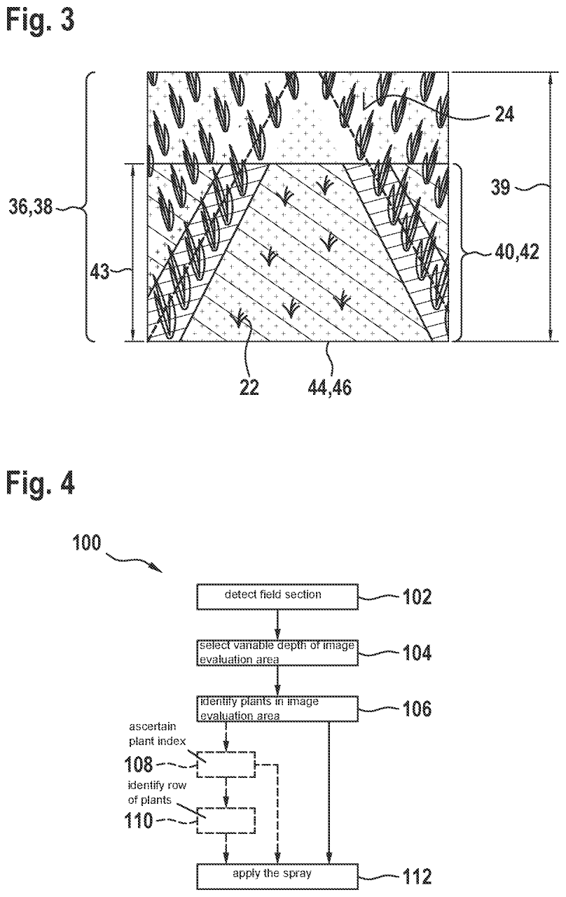

As can be seen in FIGS. 2 and 3, a field section 36 of agricultural land 24 is detected by means of optical detection unit 18 in order to obtain image information 38 from the field section 36 with a depth T(image) 39 in the direction of travel 30. The plants 22 are then identified in an image evaluation region 40 of the obtained item of image information 38, wherein the image evaluation region 40 represents a corresponding field evaluation region 42 of the detected field section 36 with a depth T (evaluation) 43 in the direction of travel 30 of the spraying device 10. According to the present invention, the depth T(evaluation) 43 of the image evaluation region 40 is variable and is selected or adjusted by means of the control unit 26 as a function of a driving speed of the spraying device 10. A rear edge 44 of the depth-variable image evaluation region 40 in the direction of travel 30 is aligned with a rear edge 46 of the image information 38. The spray 20 is then applied extensively over the field evaluation region 42 of the detected field section 38 by means of the spray nozzle unit 16 as a function of the plants 22 identified in the image evaluation region 40.

FIG. 4 shows a flowchart of a method 100 for applying a spray 20 onto agricultural land 24 using at least one spray nozzle unit 16 of an agricultural spraying device 10. The method comprises a step of detecting 102 a field section 36 of the agricultural land 24 by means of at least one optical detection unit 18 in order to obtain image information 38 on the field section 36 with a depth T(image) 39 in the direction of travel 30 of the spraying device 10. The method 100 further comprises a step of selecting 104 a variable depth T(evaluation) 43 of the image evaluation region 40 by means of the control unit 26. The method 100 further comprises a step of identifying 106 plants 22 in the image evaluation region 40 of the obtained item of image information 38 by means of the control unit 26, wherein the image evaluation region 40 represents a corresponding field evaluation region 42 of the detected field section 36 with a depth T (evaluation) 43 in the direction of travel 30 of the spraying device 10. The method 100 further comprises a step of applying 112 the spray 20 to the field evaluation region 42 of the detected field section 36 by means of the spray nozzle unit 16 of the agricultural spraying device 10 as a function of the plants 22 identified in the image evaluation region 40.

The method 100 further comprises an optional step of ascertaining 108 a plant index for the depth-variable image evaluation region 40 using the identified plants 22 in the depth-variable image evaluation region 40 by means of the control unit, wherein, in the step of applying 112, the spray 20 is applied onto the field evaluation region 42 as a function of the ascertained plant index, in particular upon reaching and/or falling below and/or exceeding a defined threshold value for the plant index. Alternatively or additionally, the method 100 comprises an optional step of identifying 110 rows of plants in the depth-variable image evaluation region 40 and/or image information 38 using the identified plants 22 by means of the control unit 26, wherein, in the step of applying 112, the spray 20 is also applied as a function of identified rows of plants.

If an embodiment example comprises an “and/or” conjunction between a first feature and a second feature, this is to be read to mean that the embodiment example comprises both the first feature and the second feature according to one embodiment, and either only the first feature or only the second feature according to another embodiment.

1-15. (canceled)

16. A method for applying a spray onto agricultural land using at least one spray nozzle unit of an agricultural spraying device, comprising the following steps:
detecting a field section of the agricultural land using at least one optical detection unit to obtain image information on the field section with a depth in a direction of travel of the spraying device;
identifying plants in an image evaluation region of the obtained image information using a control unit, wherein the image evaluation region represents a corresponding field evaluation region of the detected field section with a depth in the direction of travel of the spraying device; and
applying the spray onto the field evaluation region of the detected field section using the spray nozzle unit of the agricultural spraying device as a function of the plants identified in the image evaluation region;
selecting a variable depth of the image evaluation region using the control unit.

17. The method according to claim 16, wherein the depth of the depth-variable image evaluation region is selected by the control unit as a function of a speed of the agricultural spraying device in the direction of travel.

18. The method according to claim 16, wherein the depth of the depth-variable image evaluation region is selected by the control unit as a function of a frame rate of detected field sections and/or a variable related to a temperature of the control unit.

19. The method according to claim 16, wherein a rear edge of the depth-variable image evaluation region in the direction of travel of the agricultural spraying device is aligned with a rear edge of the image information in the direction of travel of the agricultural spraying device.

20. The method according to claim 16, wherein a rear edge of the depth-variable image evaluation region in the direction of travel of the agricultural spraying device is selected by the control unit as a function of a speed of the agricultural spraying device in the direction of travel.

21. The method according to claim 16, wherein the depth-variable image evaluation region has a minimum depth of 20% of the depth of the image information and/or a maximum depth of 100% of the depth of the image information.

22. The method according to claim 16, wherein a width of the depth-variable image evaluation region is less than a width of the image information.

23. The method according to claim 16, wherein the field section is detected with an angle of inclination of an optical axis of the optical detection unit of greater than 0° relative to vertical in the direction of travel of the spraying device.

24. The method according to claim 16, further comprising:
ascertaining a plant index for the depth-variable image evaluation region using the identified plants in the depth-variable image evaluation region using the control unit, wherein, in the step of applying, the spray is applied onto the field evaluation region as a function of the ascertained plant index, upon reaching and/or falling below and/or exceeding a defined threshold value for the plant index.

25. The method according to claim 24, wherein the plant index represents a degree of coverage of the field evaluation region of plant material and/or a quantity of plant material in the respective field evaluation region and/or a number of identified plants in the field evaluation region.

26. The method according to claim 16, further comprising:
identifying rows of plants in the depth-variable image evaluation region and/or the image information using the identified plants in the image information by the control unit, wherein in the step of applying, the spray is also applied as a function of identified rows of plants.

27. A control unit, configured to:
identify plants in an image evaluation region of an obtained item of image information of a detected field section of agricultural land with a depth in a direction of travel of an agricultural spraying device, wherein the image evaluation region represents a corresponding field evaluation region of the detected field section with a depth in the direction of travel of the spraying device;
output a control signal to at least one spray nozzle unit of the spraying device as a function of the plants identified in the image evaluation region to apply the spray onto the field evaluation region of the detected field section; and
select a variable depth of the image evaluation region as a function of a speed of the spraying device in the direction of travel.

28. An agricultural spraying device for applying a spray onto agricultural land, comprising:
at least one spray nozzle unit;
at least one optical detection unit, an optical axis of the optical detection unit having an angle of inclination greater than 0° relative to vertical in a direction of travel of the spraying device; and
a control unit configured to:
identify plants in an image evaluation region of an obtained item of image information of a detected field section of agricultural land with a depth in the direction of travel of the spraying device, wherein the image evaluation region represents a corresponding field evaluation region of the detected field section with a depth in the direction of travel of the spraying device,
output a control signal to the at least one spray nozzle unit as a function of the plants identified in the image evaluation region to apply the spray onto the field evaluation region of the detected field section, and
select a variable depth of the image evaluation region as a function of a speed of the spraying device in the direction of travel.

29. A non-transitory machine-readable storage medium on which is stored a computer program for applying a spray onto agricultural land using at least one spray nozzle unit of an agricultural spraying device, the computer program, when executed by a processor, causing the processor to perform the following steps:
detecting a field section of the agricultural land using at least one optical detection unit to obtain image information on the field section with a depth in a direction of travel of the spraying device;
identifying plants in an image evaluation region of the obtained image information using a control unit, wherein the image evaluation region represents a corresponding field evaluation region of the detected field section with a depth in the direction of travel of the spraying device; and
applying the spray onto the field evaluation region of the detected field section using the spray nozzle unit of the agricultural spraying device as a function of the plants identified in the image evaluation region;
selecting a variable depth of the image evaluation region using the control unit.
